(19) United States
(12) Patent Application Publication
(10) Pub. No.: US 2019/0319513 A1
(43) Pub. Date: Oct. 17, 2019

(54) SYSTEM AND A METHOD FOR POWER GENERATION

(71) Applicant: Rajeev Hiremath, Karnataka (IN)

(72) Inventor: Rajeev Hiremath, Karnataka (IN)

(21) Appl. No.: 16/251,666

(22) Filed: Jan. 18, 2019

(30) Foreign Application Priority Data
Jan. 19, 2018 (IN) 201841002310

(51) Int. Cl. H02K 7/18; F03B 13/00

(52) U.S. Cl. CPC H02K 7/1823; F03B 17/061; F03B 13/00

(57) ABSTRACT

A system for power generation, comprises piping for carrying a high density pressurized gas, the piping forming a closed loop and having an inlet for receiving the pressurized gas, one or more velocity and pressure enhancers connected along the piping and a turbomachinery assembly connected along the piping. The piping is adapted to receive the pressurized gas via the inlet and recirculate the pressurized gas inside the closed loop. The one or more velocity and pressure enhancers are configured to be operated with one or more of electrical power, hydraulic power and pneumatic power, to maintain flow and velocity of the pressurized gas, inside the closed loop. Also, the turbomachinery assembly is configured to generate mechanical power from kinetic energy and mass flow of the pressurized gas.

### CROSS REFERENCE TO RELATED APPLICATIONS

The present application is a Convention Application taking priority under 35 U.S.C. 119 from Indian Patent Application No. 201841002310, filed on Jan. 19, 2018, the contents of which are incorporated herein by reference.

### TECHNICAL FIELD

The present invention relates to generation of power in system(s) utilizing kinetic energy of a working fluid. More specifically the invention relates to a system and a method for power generation, through turbomachinery, by utilizing high velocity and pressure with high mass flow of the working fluid for generation of mechanical energy in such systems.

### BACKGROUND ART

In power generating systems, high temperature and pressure is required for generating high velocities and mass flow to generate mechanical energy, such as rotary power and for electricity generation. The rotary power is achieved through use of turbines or heat engines, where the rotary power is gained by expanding the working fluid through the turbine, wherein the drops in temperature and pressure is proportional to the rotary power. For this purpose, compressor and pressure pumps are used to increase the pressure of working fluid utilized in the power generating systems and fossil fuel is combusted to increase the temperature of the working fluid. To increase mass flow of combusted gases, combustion is carried out at higher pressure in case of gas turbine, however, in case of steam turbines, the combustion is carried usually at negative pressure, while the steam generated is at higher pressure through use of pressure pumps. The power needed to drive the compressor reduces the net output, consuming more fuel to do the same amount of work. Further, velocity and high mass flow is required for most of the applications, nozzles or equivalent arrangements are used to enhance the velocity by reducing pressure and temperature while maintaining the same mass flow. Mass flow through the turbine is usually at elevated temperatures and pressures which reduces the durability of equipment involved. To overcome on shorter life, specialized materials are used along with cooling arrangement to withstand operating temperatures of working fluid. In some cases, usage of cooling arrangements leads to reduction in thermal efficiency.

In case of gas turbine-based power generating system, atmospheric air is compressed at required pressure to get higher mass flow and fuel is combusted in to it to generate high temperature. The high temperature high pressure gases are passed through nozzles to increase velocity of the gases. Further, this generated velocity is used in gas turbine to generate rotary power. Similarly, in steam-based power generating systems, high pressure steam is generated in boilers by using pressure pumps. The steam is later expanded in a nozzle to generate high velocity. Further, this generated velocity is used in steam turbine to generate rotary power. Moreover, large amount of powers is consumed by compressor and pressure pumps to get required mass flow and in the process a large carbon footprint is generated.

Therefore, in light of the above discussion, there is a need in the art for a system and a method for power generation that utilizes high pressure and velocity along with increased mass flow rate, while not requiring energy from combustion of fossil fuels.

### SUMMARY OF THE INVENTION

The present invention is described hereinafter by various embodiments. This invention may, however, be embodied in many different forms and should not be construed as limited to the embodiment set forth herein. Rather, the embodiment is provided so that this disclosure will be thorough and complete and will fully convey the scope of the invention to those skilled in the art.

Embodiments of the present invention aim to provide a system and a method for power generation that allows generation of pressure and velocity along with increased mass flow rate while consuming less energy.

According to a first aspect of the present invention there is provided a system for power generation, the system comprising piping for carrying a high density pressurized gas, the piping forming a closed loop and having an inlet for receiving the pressurized gas, one or more velocity and pressure enhancers connected along the piping, and a turbomachinery assembly connected along the piping. The piping is adapted to receive the pressurized gas via the inlet and recirculate the pressurized gas inside the closed loop. The one or more velocity and pressure enhancers are configured to be operated with one or more of electrical power, hydraulic power and pneumatic power, to maintain flow and velocity of the pressurized gas, inside the closed loop. Also, the turbomachinery assembly is configured to generate mechanical power from kinetic energy and mass flow of the pressurized gas.

In accordance with an embodiment of the present invention, the one or more velocity and pressure enhancers are configured to maintain the velocity of the pressurized gas, inside the closed loop, within a range from subsonic velocities to supersonic velocities.

In accordance with an embodiment of the present invention, the system further comprises a plurality of pressure sensors provided at a number of locations along the piping, a plurality of temperature sensors provided at a number of locations along the piping, for monitoring and control of temperature of the pressurized gas and a plurality of velocity sensors located at a number of locations along the piping for monitoring and control of the velocity and mass flow rate of the pressurized gas.

In accordance with an embodiment of the present invention, the piping has insulation provided along the piping in order to minimize heat transfer along the piping.

In accordance with an embodiment of the present invention, the one or more velocity and pressure enhancers include one or more of compressors, inline fans and turbo-blowers.

In accordance with an embodiment of the present invention, turbine blades design and gap between blades and casing is adjustable in order to achieve a predetermined rotational speed and power.

In accordance with an embodiment of the present invention, the one or more velocity and pressure enhancers are arranged in one or more of a series arrangement and a parallel arrangement along the piping.

In accordance with an embodiment of the present invention, the parallel arrangement of the one or more velocity and pressure enhancers is located upstream of the turbomachinery assembly.

In accordance with an embodiment of the present invention, the one or more velocity and pressure enhancers are operated using variable frequency and/or variable speed drives to control mass flow rate of the pressurized gas.

In accordance with an embodiment of the present invention, rotational speeds of the one or more velocity and pressure enhancers are more than 3000 rpm.

In accordance with an embodiment of the present invention, the turbomachinery assembly includes one or more of turbines, compressors, fans and blowers.

In accordance with an embodiment of the present invention, the one or more velocity and pressure enhancers has at least one velocity and pressure enhancer immediately downstream of the turbomachinery assembly, in order to generate a pressure differential across blades of the turbomachinery assembly.

In accordance with an embodiment of the present invention, weights of rotating parts within the turbomachinery assembly are designed in correlation with power and torque requirements of an application.

In accordance with an embodiment of the present invention, the rotating parts are adapted to receive additional weights.

In accordance with an embodiment of the present invention, the system further comprises a heat exchanger adapted to heat or cool the pressurized gas.

In accordance with an embodiment of the present invention, the system further comprises a plurality of flow control valves provided along the piping, wherein the plurality of flow control valves is adapted to isolate a section of the piping, the isolated section having a lower pressure as compared to rest of the piping.

In accordance with an embodiment of the present invention, the system further comprises a nozzle provided upstream of the turbomachinery assembly, the nozzle being one or more of convergent type nozzles, divergent type nozzles and convergent-divergent type nozzles, wherein the nozzle is adapted to enhance the velocity of the pressurized gas in the piping, just before the pressurized gas enters the turbomachinery assembly.

In accordance with an embodiment of the present invention, the piping has variable cross-sectional area.

In accordance with an embodiment of the present invention, the turbomachinery assembly includes a clutch and a rotational energy storage device on either side of a turbine unit, the clutch and the rotational energy storage device, on either side, being connected between a load and the turbine unit, the rotational energy storage device including a flywheel, wherein the rotational energy storage device is adapted to store excess power that has not been consumed by the load, in form of rotational power.

According to a second aspect of the present invention, there is provided a method for power generation, the method comprising steps of receiving a pressurized gas into piping via an inlet of the piping connected to a compressor and an inlet of the compressor being connected to a storage tank holding the pressurized gas, the piping forming a closed loop, recirculating the pressurized gas inside the closed loop, maintaining flow and velocity of the pressurized gas, inside the closed loop, using one or more velocity and pressure enhancers connected along the piping and generating mechanical power from the kinetic energy and mass flow of the pressurized gas, using a turbomachinery assembly connected along the piping.

In accordance with an embodiment of the present invention, the velocity of the pressurized gas, inside the closed loop, is maintained within a range from subsonic velocities to supersonic velocities.

In accordance with an embodiment of the present invention, pressure ratios across an inlet and outlet of the turbomachinery assembly are maintained within a range of 1.001 to 10.

In accordance with an embodiment of the present invention, the pressurized gas is selected based on characteristics including one or more of molecular weight and supercritical nature in relation to pressure and temperature.

In accordance with an embodiment of the present invention, the method further comprises a step of adjusting the pressure and temperature of the pressurized gas to get a predetermined density of the pressurized gas.

In accordance with an embodiment of the present invention, the method further comprises a step of externally heating the pressurized gas to increase the temperature of the pressurized gas, using a heat exchanger.

In accordance with an embodiment of the present invention, the method further comprises a step of maintaining pressure of the pressurized gas above the atmospheric pressure to increase mass flow and the velocity of the pressurized gas.

In accordance with an embodiment of the present invention, the pressure of the pressurized gas is maintained to be more than 2 bars above the atmospheric pressure.

In accordance with an embodiment of the present invention, the mechanical power generated, and the rotational speed of the turbomachinery assembly is in correlation with the velocity and density of the pressurized gas.

In accordance with an embodiment of the present invention, the method further comprises a step of increasing velocity of the pressurized gas, using a nozzle.

According to a third aspect of the present invention, there is provided an apparatus of multiple systems for power generation, the apparatus comprising a plurality of systems for power generation along a common shaft, in one or more of series and parallel arrangements.

### BRIEF DESCRIPTION OF THE ACCOMPANYING DRAWINGS

So that the manner in which the above recited features of the present invention can be understood in detail, a more particular description of the invention, briefly summarized above, may have been referred by examples, some of which are illustrated in the appended drawings. It is to be noted, however, that the appended drawings illustrate only typical examples of this invention and are therefore not to be considered limiting of its scope, for the invention may admit to other equally effective examples.

These and other features, benefits, and advantages of the present invention will become apparent by reference to the following text figure, with like reference numbers referring to like structures across the views, wherein:

FIG. 1A illustrates a system for power generation, in accordance with an embodiment of the present invention;

FIG. 1B illustrates the system for power generation, in accordance with another embodiment of the present invention;

FIG. 10 illustrates the system for power generation, in accordance with yet another embodiment of the present invention;

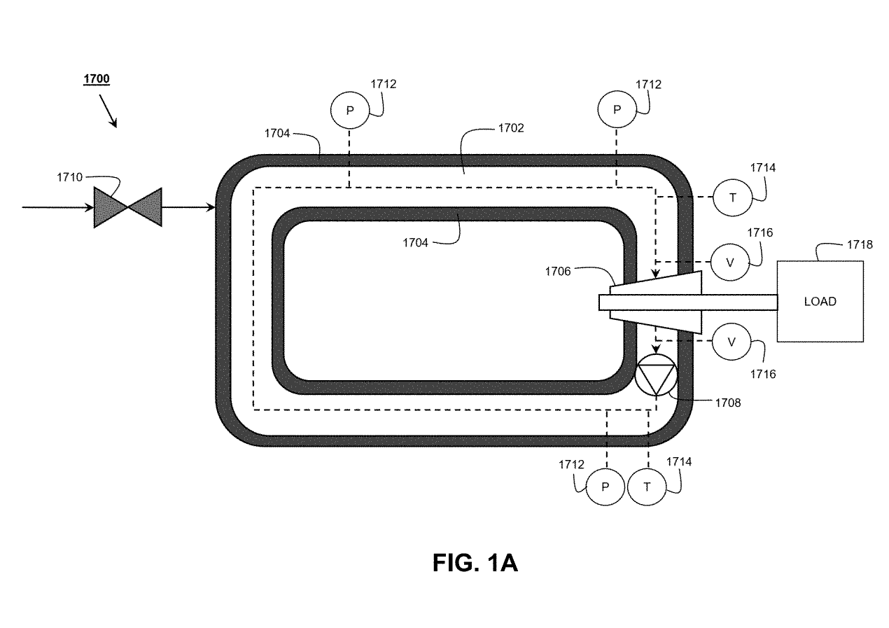

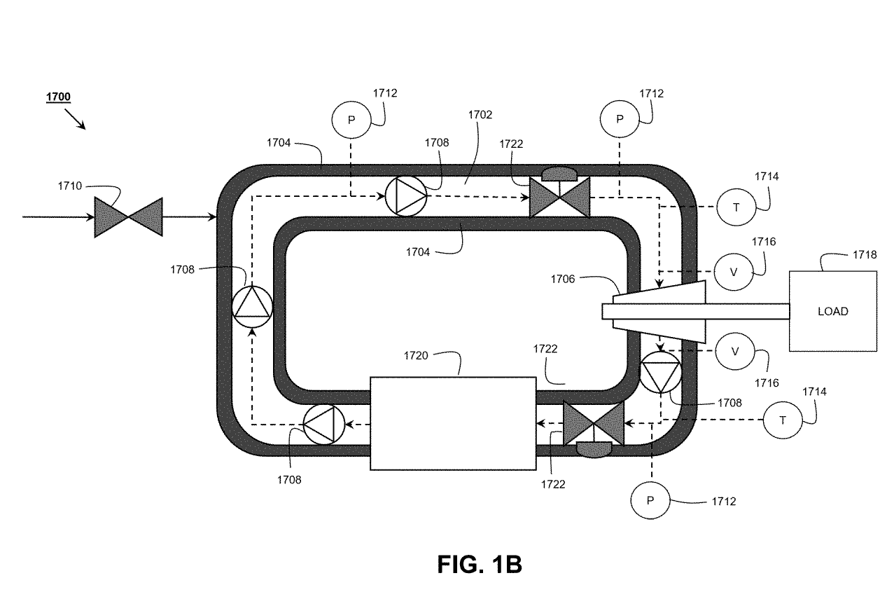

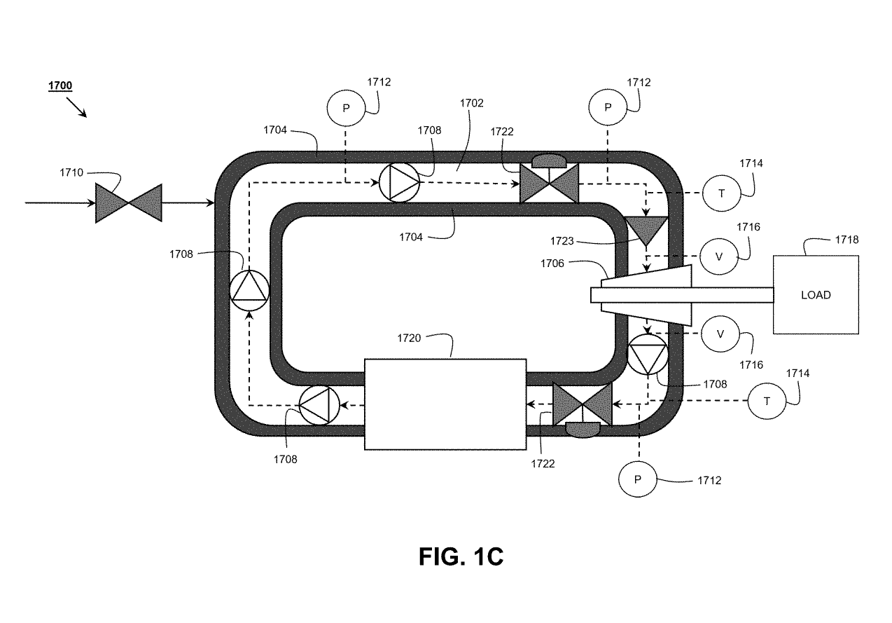

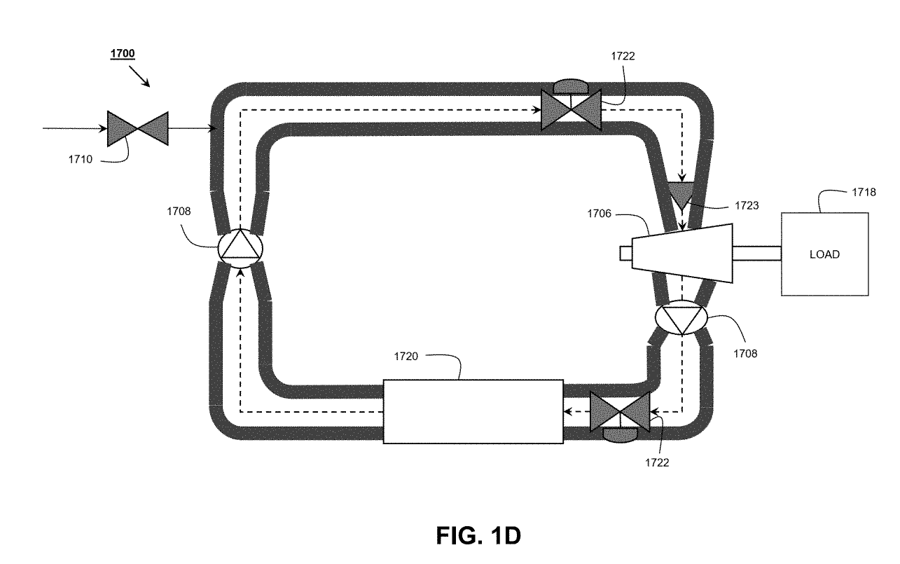

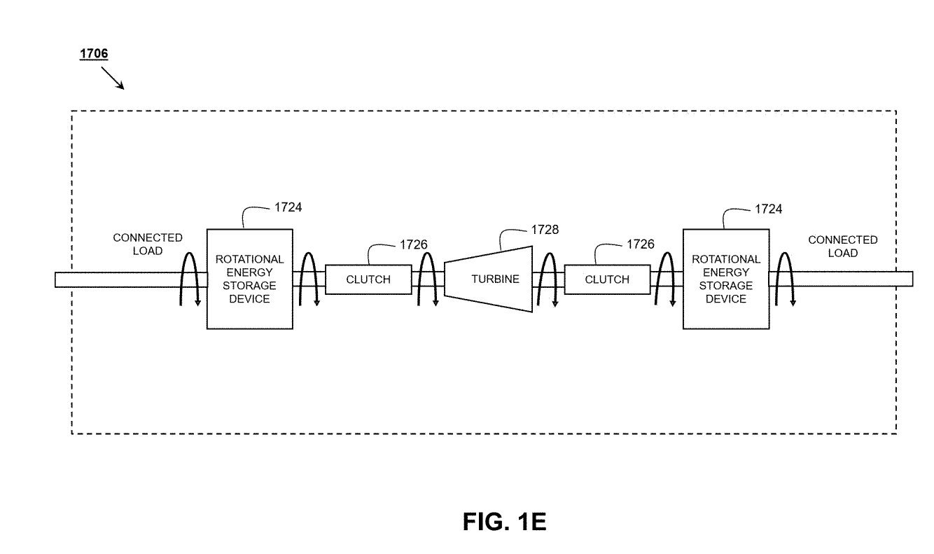

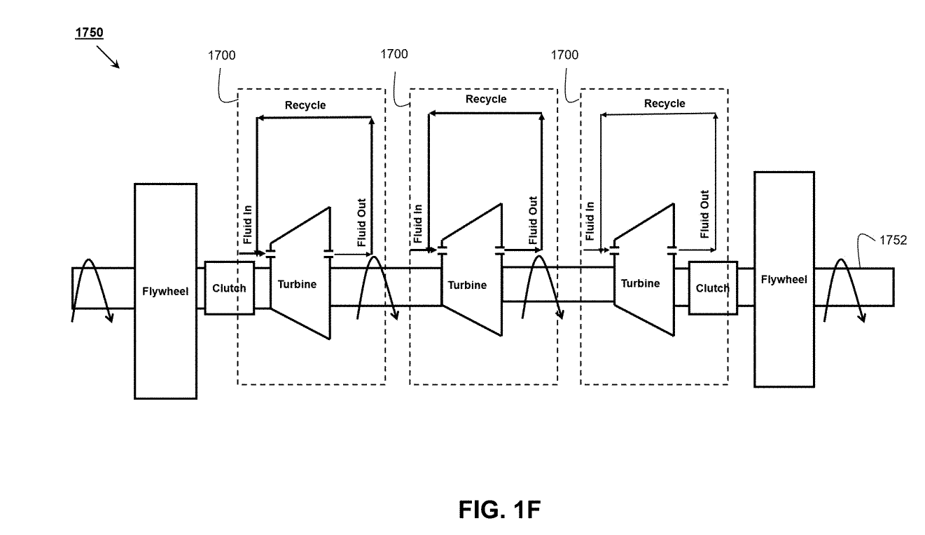

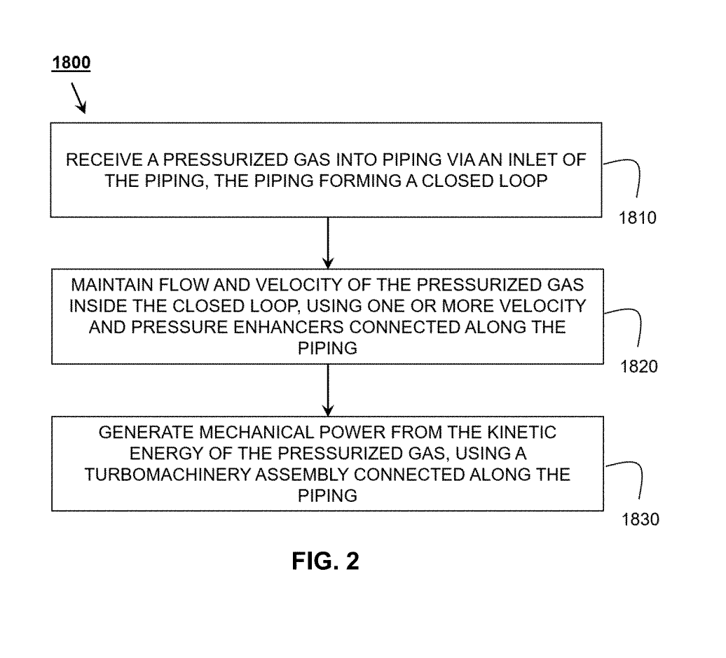

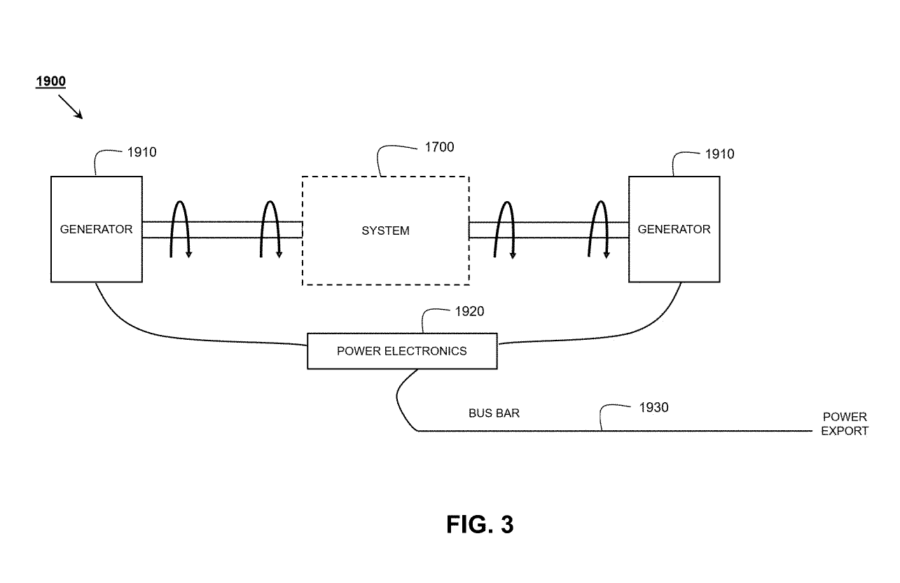

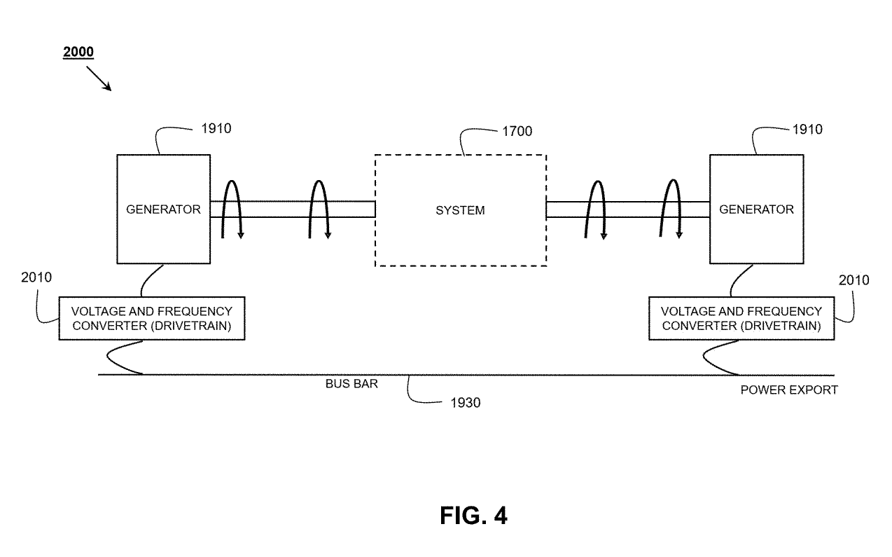

FIG. 1D illustrates the system for power generation, in accordance with yet another embodiment of the present invention;

FIG. 1E illustrates a turbomachinery assembly of the system for power generation, in accordance with an embodiment of the present invention;

FIG. 1F illustrates an apparatus of multiple systems of power generation, along a common shaft, in accordance with an embodiment of the present invention;

FIG. 2 illustrates a method for power generation, in accordance with an embodiment of the present invention;

FIG. 3 illustrates an application of the system of FIG. 1A to 1D, for electrical power generation, in accordance with an embodiment of the present invention;

FIG. 4 illustrates an application of the system of FIG. 1A to 1D, for electrical power generation, in accordance with another embodiment of the present invention;

FIG. 5 illustrates an application of the system of FIG. 1A to 1D, for mechanical power generation, in accordance with another embodiment of the present invention;

FIG. 6 illustrates an application of the system of FIG. 1A to 1D, for automotive applications, in accordance with an embodiment of the present invention;

FIG. 7 illustrates an application of the system of FIG. 1A to 1D for automotive applications, in accordance with another embodiment of the present invention; and

FIG. 8 illustrates an application of the system of FIG. 1A to 1D for marine applications, in accordance with another embodiment of the present invention.

### DETAILED DESCRIPTION OF THE PREFERRED EMBODIMENTS

While the present invention is described herein by way of example using embodiments and illustrative drawings, those skilled in the art will recognize that the invention is not limited to the embodiments of drawing or drawings described, and the embodiments are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like are included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

Pressurized gases generally have very high densities (typically between 15 kg/m³ to 1500 kg/m³) as compared to its gaseous forms at lower or ambient pressures. And introduction of the pressurized gases into, a closed loop system, in sufficiently high quantities gives rise to a very high-density gas. This high-density gas with increased velocity would be a concentrated source of kinetic energy, that may be used to generate mechanical rotational power, through turbomachinery.

The present invention offers a system and a method for power generation, that are designed as explained above, in such a way that minimum drop in pressure and temperature is achieved across a turbomachinery assembly, by adjusting mass flow rate of the pressurized gas as a working fluid. The pressure range (typically, although not limited to, 3 bars to 1000 bar or more) for the turbomachinery assembly can be used to adjust the density requirement. The velocity is generated with the help of velocity and pressure enhancers, along with nozzles provided along the closed loop, in the range of 20 m/s to up to supersonic speeds for the given pressure values.

Referring to the drawings, the invention will now be described in more detail. FIG. 1A illustrates a system 1700 for power generation, in accordance with an embodiment of the present invention. The system 1700 comprises piping 1702 for carrying a pressurized gas. The pressurized gas can be for example, but is not limited to, air, CO₂, N₂ and O₂ etc. Selection of the pressurized gas for various applications would be based on characteristics such as molecular weight, supercritical nature in relation to pressure and temperature etc. As can be seen from FIG. 1A, the piping 1702 forms a closed loop and has an inlet for receiving the pressurized gas. A valve 1710 has been provided to regulate the flow of the pressurized gas into the piping 1702. Also, the piping 1702 has insulation 1704 provided along the piping 1702. The insulation 1704 is provided to minimize heat loss/gain across the piping 1702 and the system 1700. The insulation 1704 can be suited for both heating (such as glass wool) and cold fluid (such as rubber-based insulations) applications. Also, the piping 1702 and all connections in constituents of the system 1700 are designed to be leakproof to minimize the requirement of top-up of the pressurized gas.

Additionally, one or more velocity and pressure enhancers 1708 are connected along the piping 1702. The one or more velocity and pressure enhancers 1708 may include, for example, compressors (centrifugal or positive displacement etc.), inline fans or turbo-blowers etc. The one or more velocity and pressure enhancers 1708 may be connected in a series arrangement at various locations along the piping 1702. Alternately, the one or more velocity and pressure enhancers 1708 may be connected in a parallel arrangement at a single location along the piping 1702. The one or more pressure enhancers 1708 are configured to be operated with one or more of electrical power, hydraulic power and pneumatic power. Additionally, it is envisaged here that to ensure better control over functioning of the system 1700, in start stop and variable load operations, that the one or more velocity and pressure enhancers 1708 be operated using variable frequency and/or variable speed drives to control the mass flow rate based on the above requirements of operations. It is envisaged here that in several embodiments, rotational speeds of the one or more velocity and pressure enhancers 1708 are more than 3000 rpm. Typically, between 3000 rpm and 5,50,000 rpm and even more.

Also, a turbomachinery assembly 1706 is connected along the piping 1702. In various embodiments, the turbomachinery assembly 1706 may include turbines, compressors, fans and blowers etc. depending upon specific applications. The piping 1702 is adapted to receive the pressurized gas via the inlet and recirculate the pressurized gas inside the closed loop. The one or more velocity and pressure enhancers 1708 are configured to maintain mass flow and velocity of the pressurized gas inside the closed loop. It is envisaged that, the one or more velocity and pressure enhancers 1708 will have at least one velocity and pressure enhancer 1708 immediately downstream of the turbomachinery assembly 1706, in order to generate a pressure differential across blades of the turbomachinery assembly 1706. This would result in initiation of recirculation of the pressurized gas in the closed loop.

Also, the turbomachinery assembly 1706 is configured to generate mechanical power from kinetic energy and mass flow of the pressurized gas. In that manner, turbine blades design and gap between blades and casing is adjustable in order to achieve a predetermined rotational speed and power by velocity drop in the pressurized gas and ensuring minimal pressure drop. It is envisaged here that weights of rotating parts within the turbomachinery assembly 1706 are designed in correlation with power and torque requirements of an application. Additional weights may be added to the rotating parts to achieve a predetermined power to weight ratio.

The system 1700 also includes control and instrumentation for monitoring and control and control of the functioning of the system 1700. In various embodiments, a plurality of pressure sensors 1712 may be provided at a number of locations along the piping 1702. A plurality of temperature sensors 1714 may also be provided at a number of locations along the piping 1702, for monitoring and control of the temperature of the pressurized gas. A plurality of velocity sensors 1716 may also be located at a number of locations for monitoring and control of the velocity and the mass flow rate of the pressurized gas. Typical locations for locating velocity sensors 1716 would be just upstream and downstream of the turbomachinery assembly 1706, although this is not binding. Also, a load 1718 is connected with a power take-off shaft of the turbomachinery assembly 1706. The load 1718 here may be selected from, but is not limited to, automotive, marine, railway and electrical grid-based loads.

The system 1700 is also envisaged to include a central control system (for example DCS or SCADA) that would receive signals from the plurality of sensors discussed above and also load side sensors and use control logic to control field devices such as valves, actuators, variable speed and variable frequency drives. In addition, there may be provided additional equipment, depending upon specific applications, that may be used to enhance performance and efficiency of the system 1700.

FIG. 1B illustrates the system 1700 for power generation, in accordance with another embodiment of the present invention. As illustrated in FIG. 1B, there are shown velocity and pressure enhancers 1708 located at four locations along the piping 1702. Although the one or more velocity and pressure enhancers 1708 have been depicted to be arranged in a series arrangement, in several embodiments, the one or more velocity and pressure enhancers 1708 may also be arranged in a parallel arrangement. The parallel arrangement of the one or more velocity and pressure enhancers 1708, especially immediately upstream of the turbomachinery assembly 1706, may eliminate use of any nozzles upstream of the turbomachinery assembly 1706.

Also, a heat exchanger 1720 has been provided along the piping 1702. The heat exchanger 1720 may be, for example, a shell and tube type (parallel flow or cross flow) heat exchanger. The heat exchanger 1720 may be adapted to heat or cool the pressurized gas depending upon specific applications. For example, for heating applications, the heat exchanger 1720 may be an external heater adapted to increase the temperature of the pressurized gas. Additionally, a plurality of flow control valves 1722 may be provided along the piping 1702 adapted to isolate a section of the piping 1702, the isolated section having a lower pressure as compared to rest of the piping 1702. The plurality of flow control valves 1722 will help in control of the power generation by controlling the mass flow across the turbomachinery assembly 1706, in start stop as well as in load variation conditions.

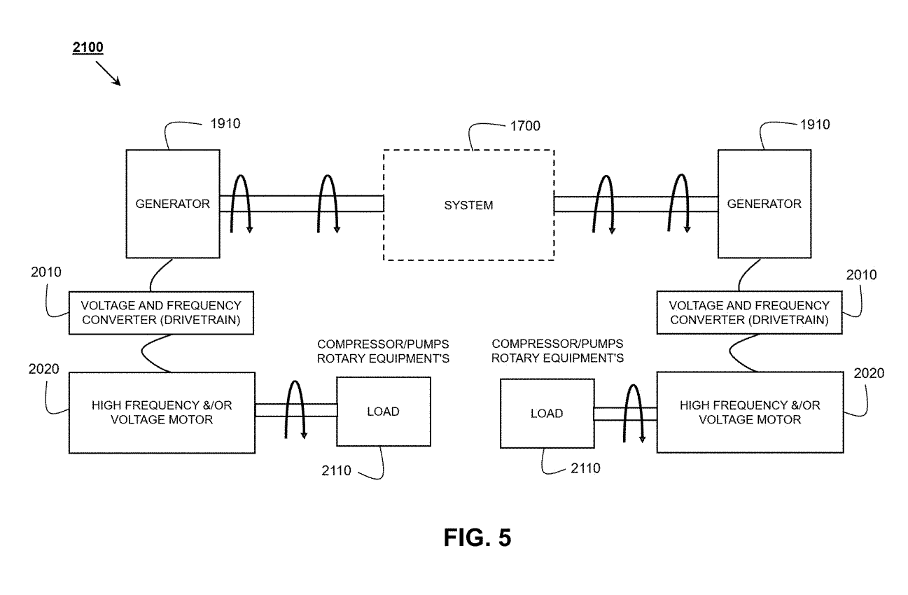

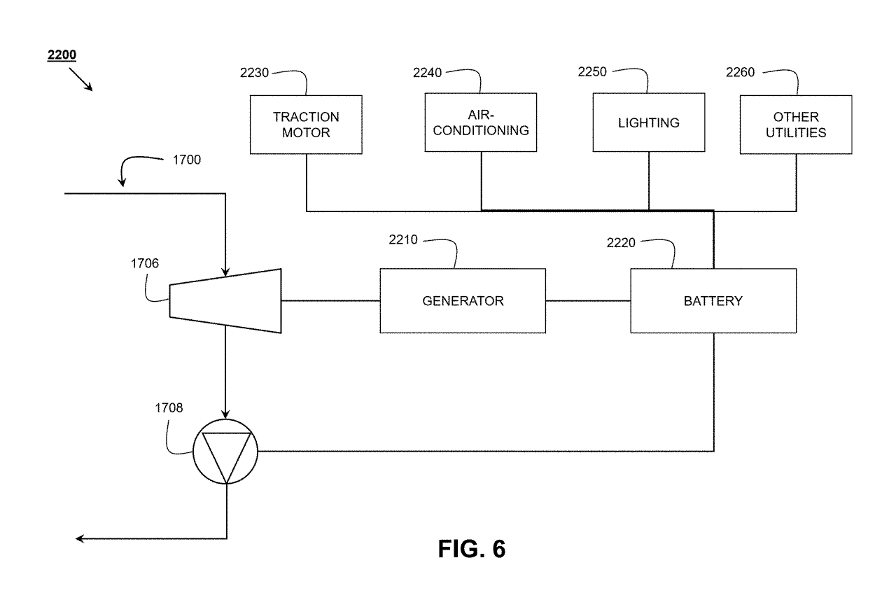

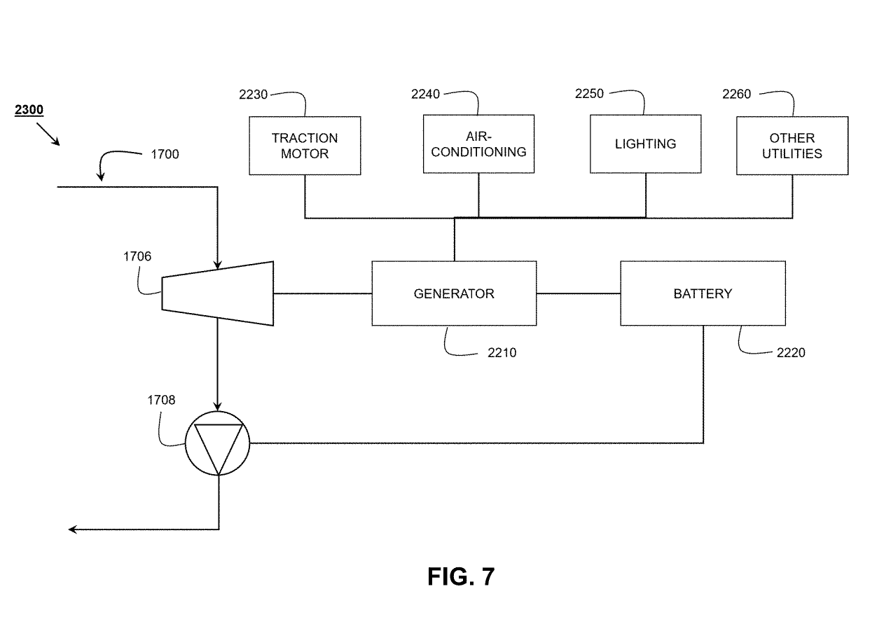

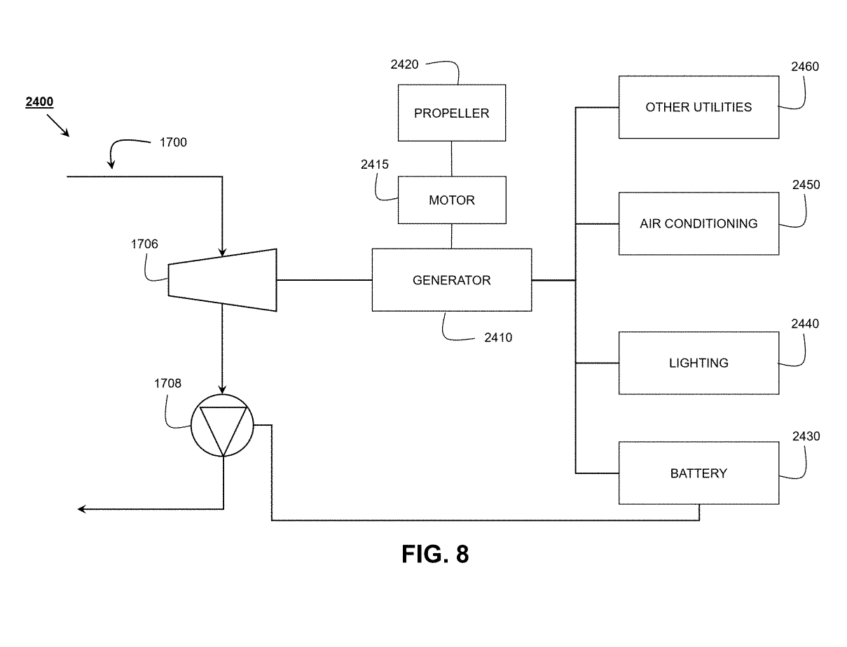

FIG. 10 illustrates the system 1700 for power generation, in accordance with yet another embodiment of the present invention. As shown in FIG. 10, a nozzle 1723 may be provided upstream of the turbomachinery assembly 1706. The nozzle 1723 is an additional nozzle here, installed outside of the turbomachinery assembly 1706, in addition to what may be nozzles that are installed within the turbomachinery assembly 1706. The nozzle 1723 is adapted to enhance the velocity of the pressurized gas in the piping 1702, just before the pressurized gas enters the turbomachinery assembly 1706. In that manner, the nozzle 1723 may be any one or more of convergent type nozzles, divergent type nozzles and convergent-divergent type nozzles.

FIG. 1D illustrates the system 1700 for power generation, in accordance with yet another embodiment of the present invention. As shown in FIG. 1D, the piping 1702 is envisaged to have variable cross-sectional area along the system 1700. For example, at certain locations (such as upstream of the turbomachinery assembly 1706), the piping 1702 may have a gradually decreasing cross-sectional area adapted for increasing the velocity of the pressurized gas, inside the closed loop and at certain locations (such as downstream of the turbomachinery assembly 1706), the piping 1702 may have gradually increasing cross-sectional area inside the closed loop.

FIG. 1E illustrates the turbomachinery assembly 1706, in accordance with an embodiment of the present invention. The turbomachinery assembly 1706 includes a clutch 1726 and a rotational energy storage device 1724 (such as a flywheel assembly) on either side of a turbine unit 1728. The clutch 1726 and the rotational energy storage device 1724, on either side, are connected between a load and the turbine unit 1708. The rotational energy storage device 1724 may include a flywheel and store excess power that has not been consumed by the load, in form of rotational power. The load here may be a generator configured to generate and store the power in battery banks. However, in various alternate embodiments, the turbine unit 1728 can be directly connected, with the generator on one or both the sides, without the need of the clutch 1726 and the rotational energy storage device 1724.

FIG. 1F illustrates an apparatus of multiple systems 1700 for power generation, along a common shaft 1752, in accordance with an embodiment 1750 of the present invention. This arrangement allows for increasing overall capacity of power generation, for loads that require such a capacity. In this manner may such modular units of the system 1700 can be installed on the common shaft 1752, in one or more of series and parallel arrangements depending upon the specific application.

FIG. 2 illustrates a method 1800 for power generation, in accordance with an embodiment of the present invention. At step 1810, the pressurized gas is received into the piping 1702 via an inlet of the piping 1702. In that manner a predetermined quantity of the pressurized gas is received in the piping 1702. The pressurized gas may be supplied from the atmosphere if the pressurized gas is air, however, in cases of gases like CO₂, N₂, O₂ or refrigerants etc., the pressurized gas would need to be supplied from storage tanks. In applications where, ambient temperatures of the working fluid are preferred for power generation, the pressurized gas loading can be carried out using suitable compressors with inbuilt cooling arrangements or if part of the working fluid is in liquid form whereupon vaporization the need for extra heat can be met with a combination of compressor heat and an external heating using the heat exchanger 1720. In scenarios, where the working fluid temperatures are higher the need for cooling arrangements in the compressor can be disregarded and extra heat can be supplied through external heating by the heat exchanger 1720. For various capacities, the pressure and temperature would be adjusted to get a predetermined density of the pressurized gas before starting. The control system will ensure that the pressure and the temperature is maintained throughout the working of the present invention.

Once the predetermined quantity of the pressurized gas is admitted into the closed loop, preferably via the valve 1710, the addition of the pressurized gas will stop. The received pressurized gas will act as a working fluid for the method 1800. The pressurized gas is in the closed loop, where volume of the closed loop is constant. The quantity of the pressurized gas may be adjusted based on the requirements of density, pressure, temperature and velocity of the working fluid. The makeup of the pressurized gas may be required only in special cases, such as accidental leakages and changes in process requirements. The insulation 1704 would prevent any heat transfer between the atmosphere and the closed loop system.

For the embodiments involving the heat exchanger 1720 as the external heater, external heating will start to increase the temperature of the pressurized gas. The pressure and temperature that may be monitored using instrumentation such a pressure gauges and temperature sensors, thereby aiding in keeping the pressure and the temperature in desired ranges. The density may also be controlled as per the process requirements by controlling the quantity of pressurized gas in the closed loop. The pressurized gas is to be recirculated in the closed loop.

At step 1820, the one or more velocity and pressure enhancers 1708 maintain the mass flow and the velocity of the pressurized gas inside the closed loop. In that manner, the mass flow rate may be increased to such an extent that desired power output may be obtained from the turbomachinery assembly 1706. It is envisaged here that pressure of the pressurized gas is maintained above the atmospheric pressure to significantly increase the mass flow and the velocity of the pressurized gas with relatively minimal increase in power consumption of the one or more pressure enhancers 1708. In several embodiments, the pressure of the pressurized gas is maintained to be more than 2 bars above the atmospheric pressure. Typical range would vary from 3 bars up to 1000 bar and above. For example, for atmospheric conditions, a blower would consume 5 hp of power and give flow of 180 kg/hr at 30,000 rpm, but under pressurized conditions of 10 bar in the closed loop, the same blower will give 1800 kg/hr and consume around 5.8 hp of power at 30,000 rpm.

For that purpose, any number of velocity and pressure enhancers 1708 may be deployed upstream and downstream of the turbomachinery assembly 1706. The recirculating pressurized gas will be used to generate the mechanical power and the pressurized gas leaving the turbomachinery assembly 1706 will be recirculated through the one or more velocity and pressure enhancers 1708, and wherever needed, also through the heat exchanger 1720. However, respective locations of the one or more velocity and pressure enhancers 1708 and the heat exchanger 1720 may be interchanged.

The instrumentation provided along the piping 1702 will allow the control system to monitor parameters such as temperatures, velocity, pressure, density and mass flow rate of the working fluid. However, wherever there are deviations found from intended values of these parameters, necessary adjustments would need to be made. For example, in case of drop in temperature below a set point, the heat exchanger 1720 would be activated by the control system. For variations in pressure, the respective speeds of the one or more velocity and pressure enhancers 1708 may be varied. In case of density variations, a compressor before the valve 1710 and the valve 1710 may be actuated to adjust the mass of the pressurized gas inside the closed loop. In that manner, the mass flow and the velocity of the pressurized gas, in the closed loop, may be controlled with the aid of the one or more velocity and pressure enhancers 1708, the heat exchanger 1720, the compressor before the valve 1710, the valve 1710 and other control equipment.

In embodiments involving the nozzle 1723, the nozzle 1723 may be used to achieve higher velocity of the pressurized gas as the working fluid. However, to achieve a predetermined velocity of the working fluid, a predetermined clearance may be provided between the nozzle 1723 and the turbomachinery assembly 1706. Alternately, the nozzle 1723 may be inbuilt into the turbomachinery assembly 1706.

At step 1830, the mechanical power is generated from the kinetic energy and mass flow of the pressurized gas, using the turbomachinery assembly 1706. The mechanical power generated and the rotational speed of the turbomachinery assembly 1706 is in correlation with the velocity and density of the pressurized gas.

The mechanical power would then be used to generate electrical power, rotary power, reciprocating power, piston power and automotive power.

In the method 1800 as described above, high density working fluid is in continuous circulating flow in the closed loop, with high velocity thus high kinetic energy. At steady state, the one or more velocity and pressure enhancers 1708 maintain the kinetic energy of the working fluid. The total power requirement for the one or more velocity and pressure enhancers 1708, at steady state, is substantially lower compared to output power of the turbomachinery unit 1706, because the power at steady state is needed only to overcome frictional losses and pressure drops. The volumetric flow rate reduction enables the one or more velocity and pressure enhancers 1708 to run at low power requirements and at the same time, the one or more velocity and pressure enhancers 1708 are able to maintain the kinetic energy of the working fluid to run the turbomachinery assembly 1706 at required rpm. The discussion above can be best represented by expression 1.

E_{1706.Output}>>Σe₁₇₀₈ (1)

Where, E_{1706.Output} represents output power generated by the turbomachinery assembly 1706 and e₁₇₀₅ represents power consumed by a velocity and pressure enhancer of the one or more velocity and pressure enhancers 1708. The one or more velocity and pressure enhancers 1708 may be powered using a part of the output power from the turbomachinery assembly 1706. The net power output may then be represented as ΔE and may be calculated using equation 2.

ΔE=E_{1706.Output}−Σe₁₇₀₈ (2)

It is envisaged here that ΔE will have a positive value and will be function of the density p and velocity v of the working fluid. This may also be represented as equation 3.

ΔE=f(ρ,v)=C·v^{x}·ρ^{y} (3)

Where, C, x and y are constants that may be experimentally determined. In various alternate embodiments, there may be one or more auxiliary power sources that may be provided to run the one or more velocity and pressure enhancer 1708.

FIG. 3 illustrates an application of the system 1700, for electrical power generation, in accordance with an embodiment 1900 of the present invention. As can be seen from FIG. 3, one or more generators 1910 may be connected with the system 1700 for electrical power generation. The one or more generators 1910 may then be connected to a power electronics unit 1920. The power electronics unit 1920 is adapted to receive the generated electrical power from the one or more generators 1910 and control and monitor power supply to wherever necessary, through a bus bar 1930. However, there may be applications, where frequency and voltage of the electrical power generated by the one or more generators 1910 may be higher than what is desired by a specific application. In such a scenario, the electrical power would need to be converted to one having desired voltage and frequency, as discussed with respect to FIG. 4 below.

FIG. 4 illustrates an application of the system 1700, for electrical power generation, in accordance with another embodiment 2000 of the present invention. Here, the one or more generators 1910 may in turn be connected to respective one or more voltage and/or frequency converters 2010. The output power of the one or more voltage and/or frequency converters 2010 is then fed to the bus bar 1930.

FIG. 5 illustrates an application of the system 1700, for mechanical power generation, in accordance with an embodiment 2100 of the present invention. The one or more voltage and/or frequency converters 2010 are in turn connected to respective one or more high frequency and/or voltage motors 2020. The one or more high frequency and/or voltage motors 2020 are then connected to one or more respective mechanical loads 2110. The one or more mechanical loads 2110 for example may include compressors, pumps and other rotary equipment.

FIG. 6 illustrates an application of the system 1700, for automotive applications, in accordance with an embodiment 2200 of the present invention. As shown in FIG. 6, the turbomachinery assembly 1706 is connected with a generator 2210 that is configured to generate electrical power. The electrical power is then stored in an automotive battery 2220. The battery 2220 may then be used to power traction motors 2230, air-conditioning 2240, lighting 2250 and other utilities 2260. The battery 2220 is also used to power the one or more velocity and pressure enhancers 1708.

FIG. 7 illustrates an application of the system 1700 for automotive applications, in accordance with another embodiment 2300 of the present invention. In this scenario, the generator 2210 is again being used to charge the battery 2220, however, the battery 2220 is being used to power the one or more velocity and pressure enhancers 1708 and the traction motors 2230, the air-conditioning 2240, the lighting 2250 and the other utilities 2260 are being powered directly by the generator 2210.

FIG. 8 illustrates an application of the system 1700 for marine applications, in accordance with an embodiment 2400 of the present invention. The power generated by the turbomachinery assembly 1706 is being used to power a marine generator 2410 to generate electrical power. The electrical power generated by the generator 2410 is being used to power propellers 2420. In addition, the electrical power generated by the generator 2410 is also being used to power utilities like lighting 2440, air conditioning 2450, other utilities 2460 and to charge a battery 2430. The battery 2430 in turn is adapted to power the one or more velocity and pressure enhancers 1708.

The system and the method for power generation offer a number of advantages, viz
1. Very low temperature of the working fluid can be used. Although, the operating temperatures may typically vary between sub-zero temperatures and relatively very high temperatures depending upon ability of materials used in the equipment, to withstand such temperatures, the temperatures will still be lower as compared to those of prior art for the same output. Moreover, the temperature drop across the turbomachinery would be relatively minimal as compared to the prior art.
2. Since we are using the working fluid at relatively lower temperatures, the working fluid will have a higher density for a given pressure value. This leads to higher mass flow rates because of comparatively higher density, thereby contributing to increased kinetic energy of the working fluid.
3. Due to increase in the density of the working fluid, the volumetric flow rate required for a particular power output will be reduced and thereby reducing the system volume.
4. Because of high velocities generated through use of velocity and pressure enhancers, like, but not limited to, turbo-blowers, high speed centrifugal blowers, high speed compressors, the expansion of the working fluid in the turbine is not needed.
5. Higher shaft power can be generated with very nominal drop in pressure across the turbomachinery. And very low pressure-ratios of 1.001 up to 10, can be maintained across the turbomachinery inlet to the outlet.
6. High efficiency, no carbon footprint, less stringent material of construction and low carbon footprint.

Various modifications to these embodiments are apparent to those skilled in the art from the description. The principles associated with the various embodiments described herein may be applied to other embodiments. Therefore, the description is not intended to be limited to the embodiments but is to be providing broadest scope consistent with the principles and the novel and inventive features disclosed or suggested herein. Accordingly, the invention is anticipated to hold on to all other such alternatives, modifications, and variations that fall within the scope of the present invention.

I claim:

1. A system (1700) for power generation, the system (1700) comprising:
piping (1702) for carrying a high density pressurized gas, the piping (1702) forming a closed loop and having an inlet for receiving the pressurized gas;
one or more velocity and pressure enhancers (1708) connected along the piping (1702); and
a turbomachinery assembly (1706) connected along the piping (1702);
wherein the piping (1702) is adapted to receive the pressurized gas via the inlet and recirculate the pressurized gas inside the closed loop;
wherein the one or more velocity and pressure enhancers (1708) are configured to be operated with one or more of electrical power, hydraulic power and pneumatic power, to maintain flow and velocity of the pressurized gas, inside the closed loop; and
wherein the turbomachinery assembly (1706) is configured to generate mechanical power from kinetic energy and mass flow of the pressurized gas.

2. The system as claimed in claim 1, further comprising:
a plurality of pressure sensors (1712) provided at a number of locations along the piping (1702);
a plurality of temperature sensors (1714) provided at a number of locations along the piping (1702), for monitoring and control of temperature of the pressurized gas; and
a plurality of velocity sensors (1716) located at a number of locations along the piping (1702) for monitoring and control of the velocity and mass flow rate of the pressurized gas.

3. The system as claimed in claim 1, wherein the one or more velocity and pressure enhancers (1708) are configured to maintain the velocity of the pressurized gas, inside the closed loop, within a range from subsonic velocities to supersonic velocities.

4. The system (1700) as claimed in claim 1, wherein the piping (1702) has insulation (1704) provided along the piping (1702) in order to minimize heat transfer along the piping (1702).

5. The system (1700) as claimed in claim 1, wherein the one or more velocity and pressure enhancers (1708) include one or more of compressors, inline fans and turbo-blowers.

6. The system (1700) as claimed in claim 1, wherein turbine blades design and gap between blades and casing is adjustable in order to achieve a predetermined rotational speed and power.

7. The system (1700) as claimed in claim 1, wherein the one or more velocity and pressure enhancers (1708) are arranged in one or more of a series arrangement and a parallel arrangement along the piping (1702).

8. The system (1700) as claimed in claim 7, wherein the parallel arrangement of the one or more velocity and pressure enhancers (1708) is located upstream of the turbomachinery assembly (1706).

9. The system (1700) as claimed in claim 1, wherein the one or more velocity and pressure enhancers (1708) are operated using variable frequency and/or variable speed drives to control mass flow rate of the pressurized gas.

10. The system (1700) as claimed in claim 9, wherein rotational speeds of the one or more velocity and pressure enhancers (1708) are more than 3000 rpm.

11. The system (1700) as claimed in claim 1, wherein the turbomachinery assembly (1706) includes one or more of turbines, compressors, fans and blowers.

12. The system (1700) as claimed in claim 1, wherein the one or more velocity and pressure enhancers (1708) has at least one velocity and pressure enhancer immediately downstream of the turbomachinery assembly (1706), in order to generate a pressure differential across blades of the turbomachinery assembly (1706).

13. The system (1700) as claimed in claim 1, wherein weights of rotating parts within the turbomachinery assembly (1706) are designed in correlation with power and torque requirements of an application.

14. The system (1700) as claimed in claim 13, wherein the rotating parts are adapted to receive additional weights.

15. The system (1700) as claimed in claim 1, further comprising a heat exchanger (1720) adapted to heat or cool the pressurized gas.

16. The system (1700) as claimed in claim 1, further comprising, a plurality of flow control valves (1722) provided along the piping (1702), wherein the plurality of flow control valves (1722) is adapted to isolate a section of the piping (1702), the isolated section having a lower pressure as compared to rest of the piping (1702).

17. The system (1700) as claimed in claim 1, further comprising a nozzle (1723) provided upstream of the turbomachinery assembly (1706), the nozzle (1723) being one or more of convergent type nozzles, divergent type nozzles and convergent-divergent type nozzles, wherein the nozzle (1723) is adapted to enhance the velocity of the pressurized gas in the piping (1702), just before the pressurized gas enters the turbomachinery assembly (1706).

18. The system (1700) as claimed in claim 1, wherein the piping (1702) has variable cross-sectional area.

19. The system (1700) as claimed in claim 1, wherein the turbomachinery assembly (1706) includes a clutch (1726) and a rotational energy storage device (1724) on either side of a turbine unit (1728), the clutch (1726) and the rotational energy storage device (1724), on either side, being connected between a load and the turbine unit (1728), the rotational energy storage device (1724) including a flywheel, wherein the rotational energy storage device (1724) is adapted to store excess power that has not been consumed by the load, in form of rotational power.

20. A method (1800) for power generation, the method (1800) comprising steps of:
receiving (1810) a pressurized gas into piping (1702) via an inlet of the piping (1702) connected to a compressor and an inlet of the compressor being connected to a storage tank holding the pressurized gas, the piping (1702) forming a closed loop;
recirculating (1820) the pressurized gas inside the closed loop, maintaining flow and velocity of the pressurized gas, inside the closed loop, using one or more velocity and pressure enhancers (1708) connected along the piping (1702); and
generating (1830) mechanical power from the kinetic energy and mass flow of the pressurized gas, using a turbomachinery assembly (1706) connected along the piping (1702).

21. The method (1800) as claimed in claim 20, wherein the velocity of the pressurized gas, inside the closed loop, is maintained within a range from subsonic velocities to supersonic velocities.

22. The method (1800) as claimed in claim 20, wherein pressure ratios across an inlet and outlet of the turbomachinery assembly (1706) are maintained within a range of 1.001 to 10.

23. The method (1800) as claimed in claim 20, wherein the pressurized gas is selected based on characteristics including one or more of molecular weight and supercritical nature in relation to pressure and temperature.

24. The method (1800) as claimed in claim 20, further comprising a step of adjusting the pressure and temperature of the pressurized gas to get a predetermined density of the pressurized gas.

25. The method (1800) as claimed in claim 20, further comprising a step of externally heating the pressurized gas to increase the temperature of the pressurized gas, using a heat exchanger (1720).

26. The method (1800) as claimed in claim 20, further comprising a step of maintaining pressure of the pressurized gas above the atmospheric pressure to increase mass flow and the velocity of the pressurized gas.

27. The method (1800) as claimed in claim 26, wherein the pressure of the pressurized gas is maintained to be more than 2 bars above the atmospheric pressure.

28. The method (1800) as claimed in claim 20, wherein the mechanical power generated, and the rotational speed of the turbomachinery assembly (1706) is in correlation with the velocity and density of the pressurized gas.

29. The method (1800) as claimed in claim 20, further comprising a step of increasing velocity of the pressurized gas, using a nozzle (1723).

30. An apparatus (1750) of multiple systems (1700) for power generation, the apparatus comprising a plurality of systems (1700) for power generation along a common shaft (1752), in one or more of series and parallel arrangements.
